(19) United States
(12) Patent Application Publication
(10) Pub. No.: US 2013/0220287 A1
(43) Pub. Date: Aug. 29, 2013

(54) EXHAUST SYSTEM HAVING DEDICATED EGR CYLINDER CONNECTION

(71) Applicant: Teoman UZKAN, Indian Head Park, IL (US)

(72) Inventor: Teoman UZKAN, Indian Head Park, IL (US)

(21) Appl. No.: 13/407,206

(22) Filed: Feb. 28, 2012

(51) Int. Cl. F02M 25/07; F02B 47/08

(52) U.S. Cl. 123/568.11

(57) ABSTRACT

An exhaust system is disclosed for use with an engine. The exhaust system may have at least one exhaust manifold connectable between all combustion chambers of the engine and the atmosphere, and at least one exhaust valve associated with each combustion chamber of the engine. The at least one exhaust valve may be movable to selectively allow exhaust to pass from each combustion chamber into the at least one exhaust manifold. The exhaust system may also have an exhaust gas recirculation circuit fluidly connectable directly to at least one of the combustion chambers of the engine and to an intake duct of the engine, and at least one exhaust gas recirculation valve associated with the exhaust gas recirculation circuit.

### TECHNICAL FIELD

The present disclosure is directed to an exhaust system and, more particularly, to an exhaust system having a dedicated cylinder connection for exhaust gas recirculation (EGR).

### BACKGROUND

Combustion engines such as diesel engines, gasoline engines, and gaseous fuel-powered engines are supplied with a mixture of air and fuel for combustion within the engine that generates a mechanical power output and a flow of exhaust gases. In order to increase the power output generated by this combustion process, the engine is often equipped with a turbocharged air induction system. The turbocharged air induction system increases engine power by forcing more air into the combustion chambers of the engine than would otherwise be possible. This increased amount of air allows for enhanced fueling that further increases the power output of the engine.

In addition to the goal of increasing engine power output, it is desirable to simultaneously reduce exhaust emissions. That is, the exhaust gases of the engine may contain a complex mixture of air pollutants generated as byproducts of the combustion process. And due to increased attention on the environment, exhaust emission standards have become more stringent. The amount of pollutants emitted to the atmosphere from an engine can be regulated depending on the type of engine, size of engine, and/or class of engine.

One method that has been implemented by engine manufacturers to comply with the regulation of exhaust emissions includes utilizing an exhaust gas recirculation (EGR) system. EGR systems operate by recirculating a portion of the exhaust produced by the engine back to the intake of the engine to mix with fresh combustion air. The resulting mixture will produce a lower combustion temperature and, subsequently, generate a reduced amount of regulated pollutants.

An exemplary EGR system is disclosed in U.S. Patent Publication No. 2010/0024419 of Pierpont et al. that published on Feb. 4, 2010 (“the '419 publication”). In particular, the '419 publication discloses an exhaust system having a first exhaust manifold, a second exhaust manifold, and an exhaust gas recirculation circuit in fluid communication with only the first exhaust manifold. The exhaust system may also have a recirculation control valve disposed within the exhaust gas recirculation circuit.

Although the system in the '419 publication may help to lower engine emissions by implementing exhaust gas recirculation, the system may still be less than optimal. In particular, because the system utilizes the exhaust manifold as a conduit for recirculated exhaust gas, the system may lack appropriate control over recirculated exhaust gas flow. That is, the exhaust manifold may not have characteristics (e.g., a volume, a cross-sectional area, a length, etc.) designed for control over recirculated exhaust gas flow. In addition, exhaust gas may only enter the exhaust manifold of the '419 system via conventional exhaust valves within the engine, which may result in an undesired flow timing, flow volume, flow pressure, and/or flow temperature. Finally, use of the exhaust manifold to conduct recirculated exhaust gas could result in undesired flow interactions with normal operations of the engine.

The disclosed exhaust system is directed to overcoming one or more of the problems set forth above and/or other problems of the prior art.

### SUMMARY

In one aspect, the disclosure is directed toward an exhaust system for an engine. The exhaust system may include at least one exhaust manifold connectable between all combustion chambers of the engine and the atmosphere, and at least one exhaust valve associated with each combustion chamber of the engine. The at least one exhaust valve may be movable to selectively allow exhaust to pass from each combustion chamber into the at least one exhaust manifold. The exhaust system may also include an exhaust gas recirculation circuit fluidly connectable directly to at least one of the combustion chambers of the engine and to an intake duct of the engine, and at least one exhaust gas recirculation valve associated with the exhaust gas recirculation circuit.

In another aspect, the disclosure is directed toward a method of handling exhaust from an engine. The method may include generating exhaust within combustion chambers of the engine, and selectively moving at least one exhaust valve associated with each combustion chamber to direct exhaust from all combustion chambers of the engine into at least one exhaust manifold. The method may further include directing exhaust from the at least one exhaust manifold to the atmosphere, and selectively moving at least one exhaust gas recirculation valve associated with fewer than all of the combustion chambers to send exhaust directly from the fewer than all of the combustion chambers through an exhaust gas recirculation circuit into an intake duct of the engine.

### BRIEF DESCRIPTION OF THE DRAWINGS

FIG. 1 is a cross-sectional illustration of an exemplary disclosed engine; and

FIG. 2 is a diagrammatic illustration of an exemplary disclosed system that may be used in conjunction with the engine of FIG. 1.

### DETAILED DESCRIPTION

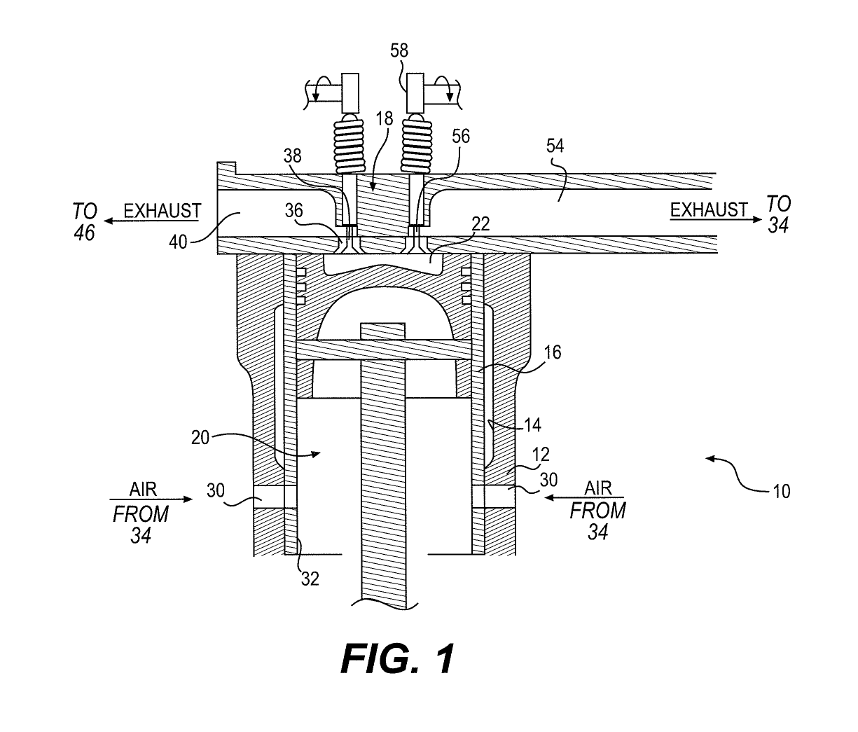

An exemplary internal combustion engine 10 is illustrated in FIG. 1. Engine 10 is depicted and described as a two-stroke diesel engine. However, it is contemplated that internal combustion engine 10 may be another type of internal combustion engine such as, for example, a four-stroke diesel engine, a two- or four-stroke gasoline engine, or a two- or four-stroke gaseous fuel-powered engine, if desired. Engine 10 may include, among other things, an engine block 12 that at least partially defines a cylinder 14, a liner 16 disposed within cylinder 14, and a cylinder head 18 connected to engine block 12 to close off an end of liner 16. A piston 20 may be slidably disposed within liner 16 and, together with liner 16 and cylinder head 18, define a combustion chamber 22. It is contemplated that engine 10 may include any number of combustion chambers 22 and that combustion chambers 22 may be disposed in an “in-line” configuration (shown in FIG. 1), in a “V” configuration, in an opposing-piston configuration, or in any other conventional configuration.

Piston 20 may be configured to reciprocate between a bottom-dead-center (BDC) or lower-most position within liner 16, and a top-dead-center (TDC) or upper-most position. In particular, piston 20 may be pivotally connected to a crankshaft (not shown) and the crankshaft may be rotatably disposed within engine block 12 so that a sliding motion of each piston 20 within liner 16 results in a rotation of the crankshaft. Similarly, a rotation of the crankshaft may result in a sliding motion of piston 20. As the crankshaft rotates through about 180 degrees, piston 20 may move through one full stroke between BDC and TDC. Engine 10, as a two-stroke engine, may have a complete cycle that includes a power/exhaust/intake stroke (TDC to BDC) and an intake/compression stroke (BDC to TDC).

During a final phase of the power/exhaust/intake stroke described above, air may be drawn and/or forced into combustion chamber 22 via one or more gas exchange ports (e.g., intake ports) 30 located within an annular surface 32 of liner 16. In particular, as piston 20 moves downward within liner 16, a position will eventually be reached at which intake ports 30 are no longer blocked by piston 20 and instead are fluidly communicated with combustion chamber 22. When intake ports 30 are in fluid communication with combustion chamber 22 and a pressure of air at intake ports 30 is greater than a pressure within combustion chamber 22, air will pass from an intake manifold (or other intake duct) 34 through intake ports 30 into combustion chamber 22. The timing at which intake ports 30 are opened (i.e., unblocked by piston 20 and fluidly communicated with combustion chamber 22) may have an effect on a pressure gradient between intake ports 30 and combustion chamber 22 and/or an amount of air that passes into combustion chamber 22 before intake ports 30 are subsequently closed by the ensuing upward movement of piston 20. The opening and/or closing timings of intake ports 30 may also have an effect on a temperature of the air directed into combustion chamber 22. Fuel may be mixed with the air before, during, or after the air is drawn into combustion chamber 22.

During the beginning of the intake/compression stroke described above, air may still be entering combustion chamber 22 via intake port 30 and piston 20 may be starting its upward stroke to mix any residual gas with air (and fuel, if present) in combustion chamber 22. Eventually, intake port 30 may be blocked by piston 20 and further upward motion of piston 20 may compress the mixture. As the mixture within combustion chamber 22 is compressed, the pressure and temperature of the mixture will increase. Eventually, the pressure and temperature of the mixture will reach a point at which the mixture combusts, resulting in a release of chemical energy in the form of pressure and temperature spikes within combustion chamber 22.

During a first phase of the power/exhaust/intake stroke, the pressure spike within combustion chamber 22 may force piston 20 downward, thereby imparting mechanical power to the crankshaft. At a particular point during this downward travel, one or more gas exchange ports (e.g., exhaust ports) 36 located within cylinder head 18 may open to allow pressurized exhaust within combustion chamber 22 to exit. In particular, as piston 20 moves downward within liner 16, a position will eventually be reached at which exhaust valves 38 move to fluidly communicate combustion chamber 22 with exhaust ports 36. When combustion chamber 22 is in fluid communication with exhaust ports 36 and a pressure of exhaust in combustion chamber 22 is greater than a pressure within exhaust ports 36, exhaust will pass from combustion chamber 22 through exhaust ports 36 into an exhaust manifold 40. The timing at which exhaust valves 38 move to open exhaust ports 36 may have an effect on a pressure gradient between combustion chamber 22 and exhaust ports 36 and/or an amount of exhaust gas that passes from combustion chamber 22 before exhaust ports 36 are subsequently closed by exhaust valves 38. The opening and/or closing timings of exhaust ports 36 may also have an effect on a temperature within combustion chamber 22. In the disclosed embodiment, movement of exhaust valves 38 may be cyclically controlled by way of a cam (not shown) that is mechanically connected to the crankshaft. It is contemplated, however, that movement of exhaust valves 38 may be controlled in any other conventional manner, as desired. It is also contemplated that exhaust ports 36 could alternatively be located within cylinder liner 16 and exhaust valves 38 omitted, if desired, such as in a loop-scavenged two-cycle engine.

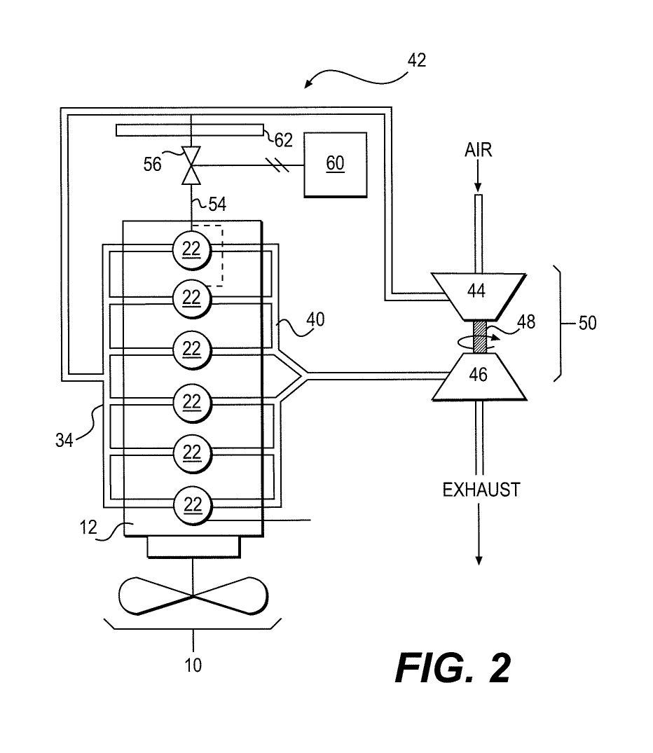

As shown in FIG. 2, engine 10 may be equipped with components configured to introduce charged air into engine 10 and discharge exhaust to the atmosphere. For example, engine 10 may include one or more air compressors 44 in fluid communication with combustion chambers 22 via intake manifold 34, and one or more turbines 46 propelled by exhaust from exhaust manifold 40 to drive compressors 44. Each compressor 44 may embody a fixed geometry compressor, a variable geometry compressor, or any other type of compressor configured to draw air from the atmosphere and compress the air to a predetermined pressure level before it enters engine 10. Turbines 46 may be directly and mechanically connected to compressors 44 by way of a shaft 48 to form a turbocharger 50. As the hot exhaust gases exiting engine 10 move through turbines 46 and expand therein, turbines 46 may rotate and drive the connected compressors 44 to pressurize inlet air.

After passing through turbines 46, the exhaust may first be treated before being released back to the atmosphere. In particular, one or more exhaust treatment devices (not shown) may be located to receive the exhaust from turbine 46. The exhaust treatment devices may include, for example, a particulate filter, one or more catalysts, or another treatment device known in the art. The exhaust treatment devices may be configured to remove, trap, reduce, or otherwise convert pollutants in the exhaust flow of engine 10 to innocuous substances.

Engine 10 may be equipped with a system 42 that is configured to recirculate exhaust from combustion chambers 22 back into combustion chambers 22 via intake manifold 34. Specifically, system 42 may include an exhaust gas recirculation (EGR) circuit 54 that is connected to fewer than all of combustion chambers 22 in a manner separate from exhaust manifold 40. In the disclosed embodiment, EGR circuit 54 is connected to only a single combustion chamber 22. It should be noted, however, that EGR circuit 54 may be connected to more than one combustion chamber 22, if desired. An EGR valve 56 may be associated with EGR circuit 54 (e.g., disposed within a conduit of EGR circuit 54) and configured to control exhaust flow through EGR circuit 54.

Returning to FIG. 1, EGR valve 56 is shown as being disposed within cylinder head 18, together with exhaust valve 38. EGR valve 56, in this embodiment, may be a mechanically-actuated valve caused to move between a flow-blocking position and a flow-passing position by a cam 58 that is driven by the crankshaft of engine 10. Cam 58 may be associated with only EGR valve 56, such that EGR valve 56 may be operated independently and separately from exhaust valves 38 and intake ports 30. EGR valve 56 may be spring-biased toward the flow-blocking position.

FIG. 2 illustrates an alternative embodiment of EGR valve 56. In this embodiment, EGR valve 56 may be an electronically-actuated valve that is selectively caused to move to any position between the flow-blocking and flow-passing positions by a controller 60. In this embodiment, controller 60 may be capable of moving valve 56 toward the flow-passing position during at least a portion of the power/exhaust/intake stroke of piston 20 such that a desired amount or flow-rate of exhaust at a desired temperature and/or pressure may be pushed from the associated combustion chamber 22 through EGR circuit 54 to intake manifold 34.

Controller 60 may embody a single or multiple microprocessors, field programmable gate arrays (FPGAs), digital signal processors (DSPs), etc. that include a means for controlling an operation of system 42. Numerous commercially available microprocessors can be configured to perform the functions of controller 60. It should be appreciated that controller 60 could readily embody a microprocessor separate from that controlling other non-exhaust related functions, or that controller 60 could be integral with a general engine microprocessor and be capable of controlling numerous engine functions and modes of operation. If separate from a general engine microprocessor, controller 60 may communicate with the general engine microprocessor via data links or other methods. Various other known circuits may be associated with controller 60, including power supply circuitry, signal-conditioning circuitry, actuator driver circuitry (i.e., circuitry powering solenoids, motors, or piezo actuators), communication circuitry, and other appropriate circuitry.

Before, during, and/or after regulating exhaust flow through EGR circuit 54 via EGR valve 56, controller 60 may receive data indicative of an operational condition of engine 10 and/or an actual flow rate, temperature, pressure, and/or constituency of exhaust within exhaust manifold 40 and/or EGR circuit 54. Such data may be received from another controller or computer (not shown), from sensors strategically located throughout system 42, and/or from a user of engine 10. Controller 60 may then utilize stored algorithms, equations, subroutines, look-up maps and/or tables to analyze the operational condition data and determine a corresponding desired flow rate and/or constituency of exhaust within conduit 54 that sufficiently reduces generation of pollutants discharged to the atmosphere. Based on the desired flow rate and/or constituency, controller 60 may then cause EGR valve 56 to open at the right timing relative to the power/exhaust/intake stroke of piston 20 such that the desired flow rate and constituency of exhaust is passed through EGR circuit 54 into intake manifold 34.

In one embodiment, the exhaust flowing through EGR circuit 54 may first be cooled prior to communication with intake manifold 34. By cooling the exhaust prior to mixing with intake air, a greater amount of exhaust and air may be forced into combustion chambers 22 prior to the compression stroke of piston 20. For this reason, an exhaust cooler 62 may be located in thermal communication with EGR circuit 54.

### INDUSTRIAL APPLICABILITY

The disclosed system may be applicable to any engine where a recirculated supply of exhaust from combustion chambers of the engine to the intake of the engine can enhance operation of the engine. The disclosed system may enhance engine operation by selectively mixing an amount of exhaust with intake air necessary to sufficiently lower a resulting combustion temperature. When combustion temperatures are maintained at a sufficiently low level, for example below about 1500° F., the production of NOx may be reduced. Operation of system 42 will now be described with reference to FIGS. 1 and 2.

During operation of engine 10, air may be drawn from the atmosphere, pressurized by compressor 44, and directed into combustion chambers 22 by way of intake manifold 34 and intake ports 30 during the end of a downward stroke and the beginning of an upward stroke of piston 20. At any time before, during, and/or after this ingress of pressurized air, fuel may be supplied to and mixed with the air inside combustion chamber 22. Further upward movement of piston 20 may result in combustion of the fuel/air mixture, generation of exhaust, and the returning downward motion of piston 20. At some point during the downward motion of piston 20, exhaust valves 38 may open to discharge exhaust from combustion chambers 22 through intake manifold to turbine 46.

EGR valve 56 may be selectively opened at any time to allow exhaust to flow from combustion chamber 22 through EGR circuit 54 and back into engine 10 via intake manifold 34. For example, EGR valve 56 may be selectively opened during at least a portion of the power/exhaust/intake stroke, during or after combustion of the air/fuel mixture when pressures within combustion chambers 22 are high enough to push the exhaust out of combustion chambers 22 and through EGR circuit 54. Exhaust should flow from combustion chambers 22 through EGR circuit 54 and into intake manifold 34 when a pressure of the exhaust is greater than a pressure of the air within intake manifold 34. Accordingly, cam 58 may be shaped and/or connected to the crankshaft in such a manner (e.g., at a desired angular relationship) such that EGR valve 56 opens at a time of sufficiently-high exhaust pressures within the corresponding combustion chamber 22. Alternatively, controller 60 may be programmed to generate an electronic command signal directed to EGR valve 56 at this desired timing causing EGR valve 56 to open to the flow-passing position.

Because operation of EGR valve 56 may be independent of operation of intake ports 30 and exhaust valves 38, the normal operations of engine 10 may be substantially unaffected thereby. In addition, because EGR circuit 54 may be dedicated to facilitating only exhaust gas recirculation, characteristics of EGR circuit 54 (e.g., material properties, volume, flow area, etc.) may be selected for optimum performance. Similarly, the dedicated nature of EGR circuit 54 may help to avoid undesired pressure and/or temperature interactions associated with normal operations of intake and/or exhaust manifolds 34, 40.

The configuration of system 42 may help to simplify exhaust gas recirculation and associated costs. In particular, because EGR valve 56 can be independently opened at a time of sufficiently high cylinder pressures, exhaust can be caused to flow through EGR circuit 54 to mix with pressurized air in intake manifold 34 without using conventional exhaust-pressurizing components. For example, system 43 may not require a conventional EGR pump or blower and associated control circuitry. This simplification may help to reduce the cost of system 42.

It will be apparent to those skilled in the art that various modifications and variations can be made to the disclosed exhaust system. Other embodiments will be apparent to those skilled in the art from consideration of the specification and practice of the disclosed exhaust system. It is intended that the specification and examples be considered as exemplary only, with a true scope being indicated by the following claims and their equivalents.

What is claimed is:

1. An exhaust system for an engine, comprising:
at least one exhaust manifold connectable between all combustion chambers of the engine and the atmosphere;
at least one exhaust valve associated with each combustion chamber of the engine and movable to selectively allow exhaust to pass from each combustion chamber into the at least one exhaust manifold;
an exhaust gas recirculation circuit fluidly connectable directly to at least one of the combustion chambers of the engine and to an intake duct of the engine; and
at least one exhaust gas recirculation valve associated with the exhaust gas recirculation circuit.

2. The exhaust system of claim 1, wherein the at least one exhaust valve and the at least one exhaust gas recirculation valve for each combustion chamber are disposed within an associated combustion chamber head.

3. The exhaust system of claim 1, wherein the at least one exhaust gas recirculation valve is operated independently of the at least one exhaust valve.

4. The exhaust system of claim 3, wherein the at least one exhaust gas recirculation valve is cam-operated.

5. The exhaust system of claim 1, wherein the at least one exhaust gas recirculation valve is disposed within a conduit of the exhaust gas recirculation circuit.

6. The exhaust system of claim 5, further including a controller in communication with the at least one exhaust gas recirculation valve and configured to selectively cause the at least one exhaust gas recirculation valve to move between a flow-passing and a flow-blocking position.

7. The exhaust system of claim 1, wherein the at least one exhaust gas recirculation valve is configured to move from a flow-blocking position toward a flow-passing position when an exhaust pressure within the associated combustion chamber is greater than an air pressure in the intake duct.

8. The exhaust system of claim 7, wherein:
the engine is a two-cycle engine; and
the at least one exhaust gas recirculation valve is configured to move from the flow-blocking position toward the flow-passing position during at least a portion of a power/exhaust stroke of the associated combustion chamber.

9. The exhaust system of claim 1, wherein the exhaust gas recirculation circuit is fluidly connectable to more than one combustion chamber of the engine.

10. The exhaust system of claim 1, further including a cooler configured to cool exhaust as it passes through the exhaust gas recirculation circuit.

11. An engine, comprising:
an engine block at least partially defining a plurality of combustion chambers;
at least one intake duct fluidly connected between the atmosphere and the plurality of combustion chambers;
at least one intake port associated with each of the plurality of combustion chambers and configured to allow a flow of air from the at least one intake duct into the plurality of combustion chambers;
at least one exhaust manifold fluidly connected between the plurality of combustion chambers of the engine and the atmosphere;
at least one exhaust valve associated with each of the plurality of combustion chambers and selectively movable to allow exhaust to pass from the plurality of combustion chambers into the at least one exhaust manifold;
an exhaust gas recirculation circuit fluidly and directly connected to fewer than all of the plurality of combustion chambers and to the intake duct; and
at least one exhaust gas recirculation valve associated with the exhaust gas recirculation circuit and movable during at least part of a power/exhaust stroke of the engine to allow exhaust from the fewer than all of the plurality of combustion chambers to pass into the intake duct when the exhaust has at least one of a desired temperature and a desired pressure.

12. The engine of claim 11, further including a turbocharger driven by exhaust in the at least one exhaust manifold to pressurize air in the at least one intake duct, wherein the exhaust gas recirculation circuit is fluidly connected to the intake duct at a location downstream of the turbocharger.

13. A method of handling exhaust from an engine, comprising:
generating exhaust within combustion chambers of the engine;
selectively moving at least one exhaust valve associated with each combustion chamber of the engine to direct exhaust from all combustion chambers of the engine into at least one exhaust manifold;
directing exhaust from the at least one exhaust manifold to the atmosphere; and
selectively moving at least one exhaust gas recirculation valve associated with fewer than all of the combustion chambers to send exhaust directly from the fewer than all of the combustion chambers through an exhaust gas recirculation circuit into an intake duct of the engine.

14. The method of claim 13, wherein selectively moving the at least one exhaust gas recirculation valve includes moving the exhaust gas recirculation valve independent of the at least one exhaust valve.

15. The method of claim 13, wherein selectively moving the at least one exhaust gas recirculation valve includes rotating a cam shaft to move the at least one exhaust gas recirculation valve.

16. The method of claim 13, wherein selectively moving the at least one exhaust gas recirculation valve includes directing an electronic signal to the at least one exhaust gas recirculation valve to cause the at least one exhaust gas recirculation valve to move.

17. The method of claim 13, wherein selectively moving the at least one exhaust gas recirculation valve includes moving the at least one exhaust gas recirculation valve during at least a portion of a power/exhaust stroke of an associated one of the combustion chambers.

18. The method of claim 17, further including directing a mixture of air and exhaust from the intake duct through ports located in liners of the combustion chambers.

19. The method of claim 13, further including passing exhaust from the at least one exhaust manifold through a turbocharger to compress air in the intake duct.

20. The method of claim 19, wherein selectively moving the at least one exhaust gas recirculation valve to direct exhaust into the intake duct includes selectively moving the at least one exhaust gas recirculation valve to direct exhaust into the intake duct at a location downstream of the turbocharger.
